(19) United States
(12) Patent Application Publication
(10) Pub. No.: US 2014/0375032 A1
(43) Pub. Date: Dec. 25, 2014

(54) DRIVER SEAT AIRBAG SYSTEM

(71) Applicant: Toyota Jidosha Kabushiki Kaisha, Toyota-shi (JP)

(72) Inventors: Osamu Fukawatase, Miyoshi-shi (JP); Hiroyuki Taguchi, Toyota-shi (JP)

(21) Appl. No.: 14/310,170

(22) Filed: Jun. 20, 2014

(30) Foreign Application Priority Data
Jun. 21, 2013 (JP) 2013-131149

(51) Int. Cl. B60R 21/239; B60R 21/233

(52) U.S. Cl. CPC B60R 21/239; B60R 21/233; B60R 2021/0009
USPC 280/729

(57) ABSTRACT

A driver seat airbag system includes: an airbag that receives a supply of gas for inflation during a collision of a vehicle and is inflated and deployed between a steering wheel and an occupant in a driver seat; an inner bag that has a smaller capacity than the airbag, receives the supply of gas for inflation during the collision of the vehicle, and is inflated and deployed to the outside in a radial direction of a rim in a position on a rim side of the steering wheel in the airbag; and a check valve that inhibits outflow of the gas in the inner bag that is inflated and deployed to the airbag.

### INCORPORATION BY REFERENCE

The disclosure of Japanese Patent Application No. 2013-131149 filed on Jun. 21, 2013 including the specification, drawings and abstract is incorporated herein by reference in its entirety.

### BACKGROUND OF THE INVENTION

1. Field of the Invention

100021 The present invention relates to a driver seat airbag system.

2. Description of Related Art

A driver seat airbag system has been disclosed that includes a main bag for accepting an occupant during a collision and a sub bag that is sewn to a portion of the main bag and is inflatable in an annular shape so as to cover a side surface of a steering wheel that opposes the occupant (see Japanese Patent Application Publication No 7-156740 (JP 7-156740 A)). In this driver seat airbag system, the sub bag functions as a reaction force surface that generates a reaction force against the occupant in a driver seat to prevent the occupant from contacting the steering wheel.

During a frontal collision (a small overlap collision) on the outside of a front side member in a vehicle width direction or during an oblique collision, the occupant in the driver seat intends to move obliquely forward in a vehicle traveling direction, that is, to a collision direction. In such a case, a distance of the occupant in the driver seat to abutment of an airbag becomes longer than that in the frontal collision, and a restraint timing of the occupant in the driver seat is thus delayed.

However, in the above-mentioned example, the sub bag and the main bag are communicated through a gas communicating hole. Thus, an internal pressure difference between both of the bags cannot be retained for a long time. Therefore, it is considered to be difficult for the sub bag to generate the reaction force against the occupant in the driver seat during the small overlap collision or during the oblique collision.

### SUMMARY OF THE INVENTION

The present invention provides a driver seat airbag system in which restraint performance of an occupant in a driver seat by an airbag during a small overlap collision or during an oblique collision is improved.

A first aspect of the present invention relates to the driver seat airbag system. The driver seat airbag system includes: an airbag that receives a supply of gas for inflation during a collision of a vehicle and is inflated and deployed between a steering wheel and an occupant in a driver seat; an inner bag that has a smaller capacity than the airbag, receives the supply of gas for inflation during the collision of the vehicle, and is inflated and deployed to the outside in a radial direction of a rim in a position on a rim side of the steeling wheel in the airbag; and a check valve that inhibits outflow of the gas in the inner bag that is inflated and deployed to the airbag.

In the above aspect, since the inner bag has the smaller capacity than the airbag, the inflation and deployment of the inner bag is completed earlier than that of the airbag during the inflation and deployment of the airbag and the inner bag, and an internal pressure thereof is increased to become a high pressure in an early stage. The check valve inhibits the outflow of the gas in the inner bag that is inflated and deployed to the airbag. Accordingly, the internal pressure of the inner bag is retained. Thus, even during the small overlap collision or during the oblique collision in which a restraint timing of the occupant in the driver seat is delayed in comparison with the restraint timing during a frontal collision, the inner bag can generate a reaction force against the occupant in the driver seat. Therefore, it is possible to improve the restraint performance of the occupant in the driver seat by the airbag during the small overlap collision and during the oblique collision.

As described above, according to the first aspect of the present invention, a superior effect can be obtained that the restraint performance of the occupant in the driver seat by the airbag during the small overlap collision and during the oblique collision can be improved.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a cross-sectional view according to a first embodiment for showing an internal structure of an airbag in a driver seat airbag system;

FIG. 2A is a lateral cross-sectional view according to the first embodiment for showing a state in which gas is distributed to an inner bag and the airbag by a rectifying member during inflation and deployment of the airbag;

FIG. 2B is a lateral cross-sectional view according to the first embodiment for showing a state in which a check valve is closed and an internal pressure of the inner bag is thereby retained when an occupant in a driver seat abuts against the airbag;

FIG. 3A is a perspective view according to the first embodiment for showing the airbag in a state before being folded;

FIG. 3B is a perspective view according to the first embodiment for showing a state in which the airbag is folded along a first folding line;

FIG. 3C is a perspective view according to the first embodiment for showing a state in which the airbag is folded along a second folding line;

FIG. 4 is a plan view according to the first embodiment for showing a state in which the occupant in the driver seat abuts against the airbag; and

FIG. 5 is a cross-sectional view for showing the internal structure of the airbag in the driver seat airbag system according to a second embodiment.

### DETAILED DESCRIPTION OF EMBODIMENTS

A description will hereinafter be made on embodiments of the present invention on the basis of the drawings.

### First Embodiment

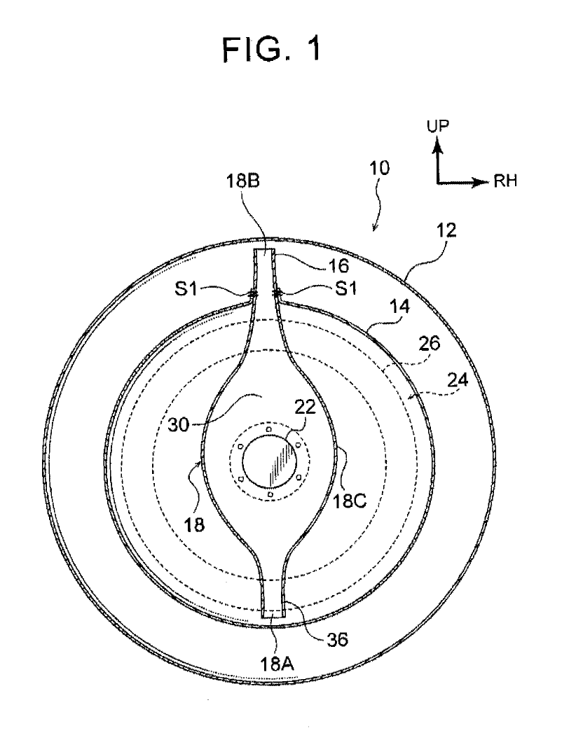

In FIG. 1, a driver seat airbag system 10 according to this embodiment is an airbag system that is installed in a steering wheel 24, for example, and includes an airbag 12, an inner bag 14, a check valve 16, a rectifying member 18, and an inflator 22.

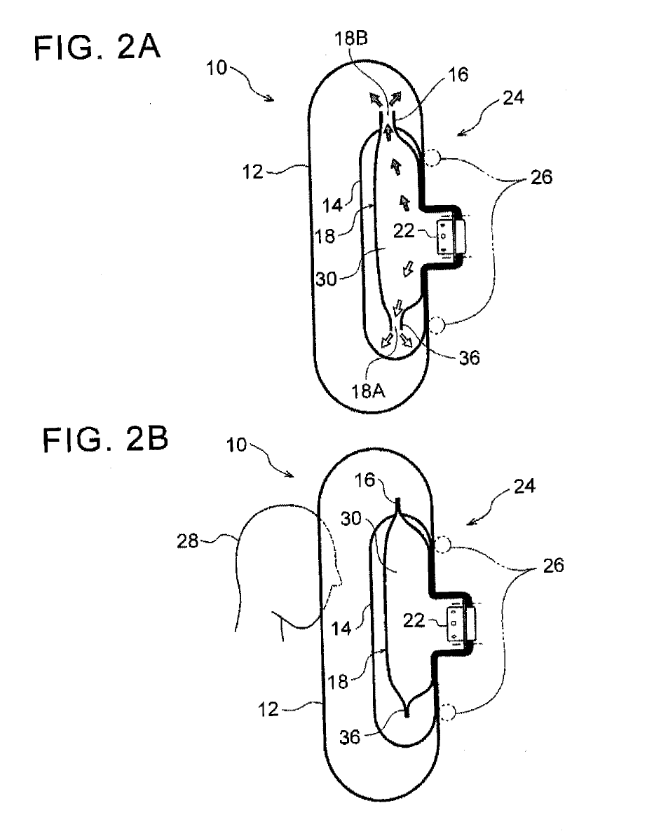

As shown in FIG. 2B, the airbag 12 is configured to receive a supply of gas for inflation from the inflator 22 and be inflated and deployed between the steering wheel 24 and an occupant in a driver seat 28 during a collision of a vehicle, for example. The airbag 12 is inflated and deployed in a substantially circular shape, for example, in a concentric manner with a rim 26 of the steering wheel 24. An outer diameter of the airbag 12 in this state is set to be larger than an outer diameter of the rim 26 of the steering wheel 24. The outer diameter of the rim 26 does not refer to a thickness of the rim 26 but refers to the outer diameter thereof when the steering wheel 24 is seen from front.

In FIG. 2A, the inner bag 14 has a smaller capacity than the airbag 12 and is configured to receive the supply of the gas for inflation from the inflator 22 and be inflated and deployed in the airbag 12 during the collision of the vehicle, for example. More specifically, the inner bag 14 is configured to be inflated and deployed to the outside in a radial direction of the rim 26 in a position on the rim 26 side of the steering wheel 24 (an opposite side from the occupant) in the airbag 12. Since the inner bag 14 is provided on the inside of the airbag 12, the airbag 12 can be considered as an “outer bag”.

At this time, the inner bag 14 is inflated and deployed in the substantially circular shape, for example, in the concentric manner with the rim 26 of the steering wheel 24. An outer diameter of the inner bag 14 in this state is set to be larger than an outer diameter of the rim 26 of the steering wheel 24 and be smaller than an outer diameter of the airbag 12. In order to arrange the inner bag 14 on the rim 26 side in the airbag 12, an inflation thickness of the inner bag 14 is set to be smaller than an inflation thickness of the airbag 12.

A base cloth of the inner bag 14 is not necessarily a separate material from a base cloth of the airbag 12, and the inner bag 14 and the airbag 12 may be configured to partially share the base cloth. For example, a portion of the base cloth of the airbag 12 may be used to configure the inner bag 14.

The gas from the inflator 22 is configured to be supplied to the inner bag 14. The inner bag 14 has a gas flow path 30 that is communicated with the airbag 12.

In FIG. 1 and FIGS. 2A, B. the rectifying member 18 is a member for distributing the gas for inflation, which is supplied from the inflator 22, to the inner bag 14 and the airbag 12, and is configured by the same cloth as the base cloth of the airbag 12, for example. The rectifying member 18 includes a first opening 18A that is opened to the inside of the inner bag 14 and a second opening 18B that is opened to the inside of the airbag 12. The second opening 18B penetrates the inner bag 14 and is projected to the inside of the airbag 12. This penetrated section of the inner bag 14 is sewn on a periphery of the rectifying member 18 (a sewn section S1). The gas flow path 30 is formed by the rectifying member 18. Here, the second opening 18B of the rectifying member 18 may adopt such a configuration that it is not projected to the inside of the airbag 12.

Since a center section 18C of the rectifying member 18 is a portion that directly receives a pressure of the gas that is spewed out of the inflator 22, a cross sectional area thereof is set to be larger than those of the first opening 18A and the second opening 18B. A cross sectional area of the rectifying member 18 is gradually reduced from this center section 18C to each of the first opening 18A and the second opening 18B.

The first opening 18A and the second opening 18B are symmetrically arranged with respect to the radial direction of the airbag 12. Here, being “symmetrical” means that the first opening 18A and the second opening 18B are located opposite from each other in the radial direction of the airbag 12. In other words, the first opening 18A and the second opening 18B oppose each other in a direction to make an angle of approximately 180° in a circumferential direction of the airbag 12. The arrangements of the openings do not have to be point-symmetrical, and a distance from the center of the airbag 12 to the first opening 18A may differ from a distance from the center of the airbag 12 to the second opening 18B. In this embodiment, the first opening 18A is arranged to be oriented a lower side of the vehicle while the second opening 18B is arranged to be oriented an upper side of the vehicle. It should be noted that orientations of the first opening 18A and the second opening 18B are not limited to this.

In FIG. 1 and FIG. 2, the check valves 16, 36 are portions to retain the internal pressure of the inner bag 14. The check valves 16, 36 are provided in the gas flow path 30. In this embodiment, the first opening 18A of the rectifying member 18 serves as the check valve 36, and the second opening 18B thereof serves as the check valve 16. Since the rectifying member 18 is configured by the cloth, both of the first opening 18A and the second opening 18B have flexibility. Accordingly, while a flow of the gas from the inside in the rectifying member 18 (the inflator 22 side) to the inner bag 14 is permitted, the flow of the gas in an opposite direction is inhibited by closing the first opening 18A (FIG. 2B). On the other hand, while a flow of the gas from the inner bag 14 side to the airbag 12 is permitted, the flow of the gas in an opposite direction is inhibited by closing the second opening 18B (FIG. 2B). Just as described, the first opening 18A of the rectifying member 18 functions as the check valve 36, and the second opening 18B thereof functions as the check valve 16.

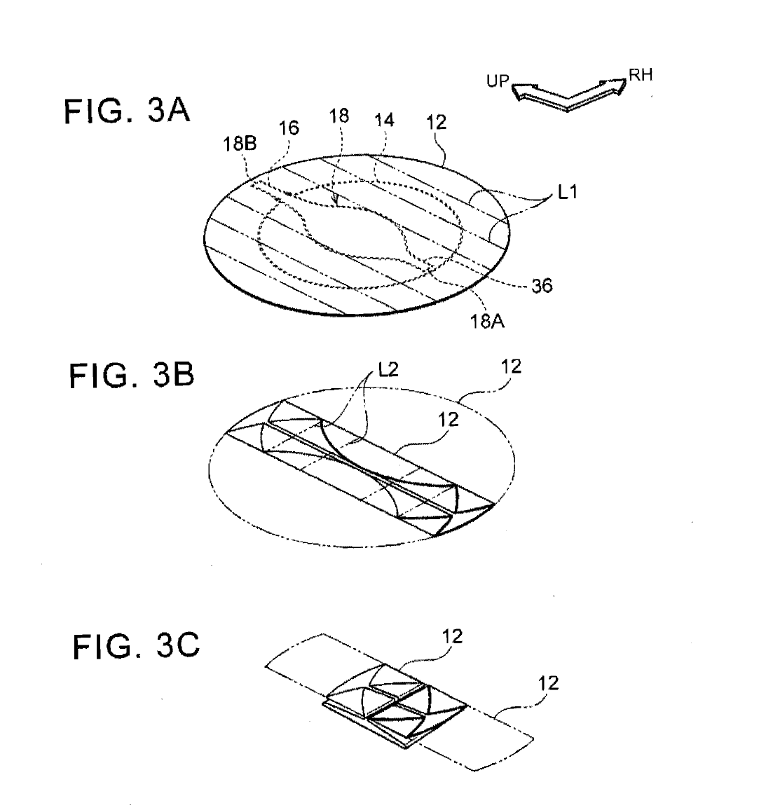

As shown in FIGS. 3A to C, after being folded along a first folding line L1 that is along a direction in which the first opening 18A and the second opening 18B are present (FIG, 3B), the airbag 12 and the inner bag 14 are folded along a second folding line L2 that is along a direction to cross the first folding line L1 (FIG. 3C). When the direction in which the first opening 18A and the second opening 18B are present is a up-and-down direction of the vehicle, the first folding line L1 is set to be parallel to the up-and-down direction of the vehicle. Meanwhile, the second folding line L2 is set to be parallel to a vehicle width direction, for example, In this case, the first folding line L1 and the second folding line L2 are orthogonal to each other. The rectifying member 18 may be located between the plural first folding lines L1.

The inner bag 14 is configured by the cloth whose inner surface is coated to increase airtightness. On the other hand, the airbag 12 is configured by the non-coated cloth.

### Operations

This embodiment is configured as above, and operations thereof will hereinafter be described. In FIGS. 2A, B, in the driver seat airbag system 10 according to this embodiment, the inflator 22 spews the gas for inflation during the collision of the vehicle, and this gas is supplied to the airbag 12. Accordingly, the airbag 12 is inflated and deployed between the steering wheel 24 and the occupant in the driver seat 28.

More specifically, as shown in FIG. 2A, the gas for inflation is first supplied to the inside of the rectifying member 18 in the inner bag 14. This gas is then supplied to the inner bag 14 through the first opening 18A of the rectifying member 18, and is also supplied to the airbag 12 through the second opening 1 SB of the rectifying member 18. Accordingly, the airbag 12 and the inner bag 14 are inflated and deployed.

The first opening 18A and the second opening 188 are symmetrically arranged with respect to the radial direction of the airbag 12, Furthermore, because of a way of folding the airbag 12 that is shown in FIGS. 3A to C, when the gas for inflation is supplied to the airbag 12, the airbag 12 is first deployed in the direction in which the first opening 18A and the second opening 18B are present, Thus, clogging of the gas during the inflation and deployment of the airbag 12 is inhibited. Therefore, the airbag 12 can stably be inflated and deployed in an early stage.

Since the inner bag 14 has the smaller capacity than the airbag 12, the inflation and deployment of the inner bag 14 is completed earlier than that of the airbag 12 during the inflation and deployment of the airbag 12 and the inner bag 14, and the internal pressure thereof is increased to become the high pressure in the early stage. The gas is thereafter supplied to the airbag 12. At this time, since the internal pressure of the inner bag 14 is higher than the internal pressure of the airbag 12, the gas in the inner bag 14 intends to flow out to the airbag 12. However, at the time, since the internal pressure of the inner bag 14 is higher than the pressure on the inside of the rectifying member 18 and the check valve 36 is closed, such outflow of the gas is inhibited. As described above, with a simple configuration in which a portion of the rectifying member 18 serves as the check valve 36, the internal pressure of the inner bag 14 is retained. The internal pressure of the inner bag 14 is desirably retained to be constantly higher than the internal pressure of the airbag 12.

Once the inflation and deployment of the airbag 12 is completed, and the supply of the gas from the inflator 22 is terminated, the pressure on the inside of the rectifying member 18 becomes lower than the internal pressure of the airbag 12. Accordingly, the gas in the airbag 12 intends to flow back to the inside of the rectifying member 18. However, since the check valve 16 is closed at the time, such back-flow of the gas is inhibited. Just as described, when the inflation and deployment of the airbag 12 is completed, both of the check valves 16, 36 are closed. Therefore, it is possible with this airbag 12 to restrain the occupant in the driver seat 28.

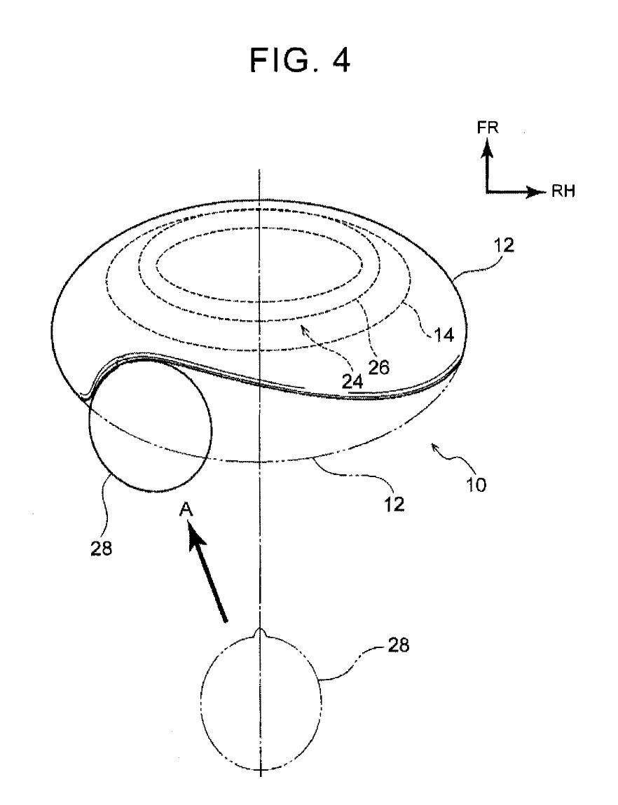

As shown in FIG. 4, the occupant (head) in the driver seat 28 intends to move obliquely forward in a vehicle traveling direction (an arrow A direction), that is, to a collision direction during a small overlap collision or during an oblique collision. In such a case, a distance of the occupant (head) in the driver seat 28 to abutment of the airbag 12 becomes longer than that during a frontal collision. In other words, a restraint timing of the occupant (head) in the driver seat 28 is delayed in comparison with that during the frontal collision. In this embodiment, the inner bag 14 is inflated and deployed to the outside in the radial direction of the rim 26 in the position on the rim 26 side of the steering wheel 24. In addition, the internal pressure of the inner bag 14 is retained by the check valves 16, 36. Thus, even during the small overlap collision and during the oblique collision, the inner bag 14 that is inflated and deployed can generate the reaction force against the occupant (head) in the driver seat 28.

Furthermore, even when the occupant (head) in the driver seat 28 abuts against a position that is apart from a center section of the airbag 12, particularly a position that corresponds to the outside of the rim 26 of the steering wheel 24, a reaction force surface can be secured by the inner bag 14. Thus, it is possible to improve restraint performance of the occupant (head) in the driver seat 28 by the airbag 12 during the small overlap collision and during the oblique collision.

Since the inner bag 14 is configured by the cloth whose inner surface is coated, the internal pressure of the inner bag 14 can stably be retained while bulking of the airbag 12 is inhibited.

In this embodiment, the internal pressure difference between the inner bag 14 and the airbag 12 can easily be adjusted by adjusting the capacities of the inner bag 14 and the airbag 12, an opening area of a vent hole (not shown) that is provided in the airbag 12, opening areas of the first opening 18A and the second opening 18B in the rectifying member 18, and the like.

### Second Embodiment

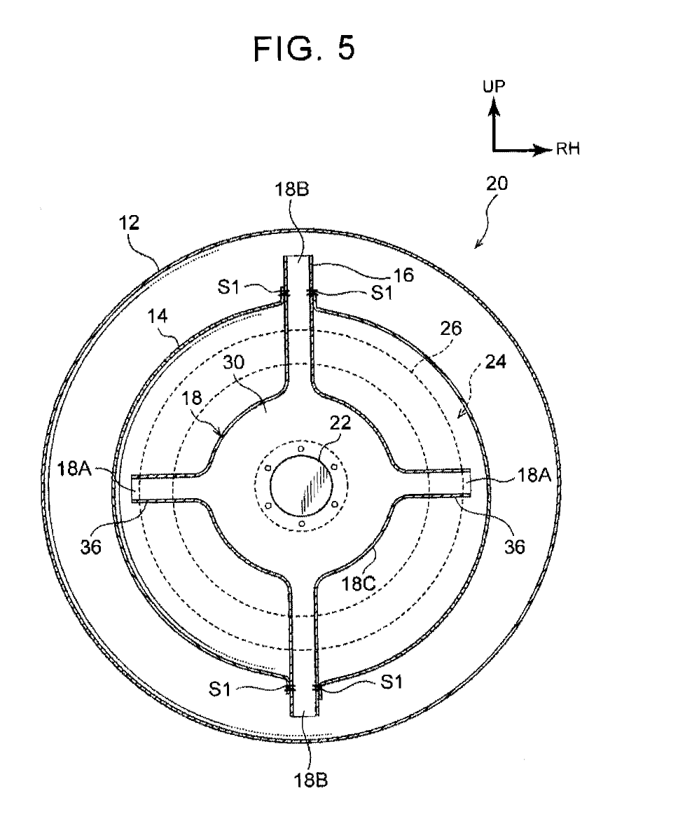

In FIG. 5, in a driver seat airbag system 20 according to this embodiment, each of a pair of the first openings 18A and a pair of the second openings 18B is symmetrically arranged with respect to the radial direction of the airbag 12. As an example, the pair of the first openings 18A is symmetrically arranged in the vehicle width direction, and the pair of the second openings 18B is symmetrically arranged in the up-and-down direction of the vehicle.

Since the other configuration is same as that of the first embodiment, the same components are denoted by the same reference numerals in the drawing, and the description thereof will not be repeated.

### Operations

This embodiment is configured as described above, and the operations thereof will hereinafter be described. In FIG. 5, in the driver seat airbag system 20 according to this embodiment, the gas for inflation is supplied from the pair of the first openings 18A that are arranged in the vehicle width direction to the inner bag 14 during the collision of the vehicle. Accordingly, the inner bag 14 is mainly inflated and deployed in the vehicle width direction. In addition, at this time, the gas for inflation is supplied from the pair of the second openings 18B that are arranged in the up-and-down direction of the vehicle to the airbag 12. Accordingly, the airbag 12 is mainly inflated and deployed in the up-and-down direction of the vehicle, Therefore, the airbag 12 and the inner bag 14 can stably be inflated and deployed.

### Another Embodiment

Each of shapes of the airbag 12 and the inner bag 14 during the inflation and deployment is not limited to the substantially circular shape but can appropriately be changed. In addition, the outer diameter of the inner bag 14 does not have to be larger than the rim 26 of the steering wheel 24 for the entire periphery. A portion of the inner bag 14 may not reach the outer diameter of the rim 26 as long as the reaction force surface can be secured when the occupant in the driver seat 28 abuts against the airbag 12. More specifically, a portion of the outer periphery of the inner bag 14 may be provided with a notched portion (a notch), for example.

A configuration may be adopted that the inner bag 14 and the airbag 12 are not communicated with each other through the gas flow path 30 and that the gas for inflation is independently supplied thereto. In addition, a configuration may be adopted that the rectifying member 18 is not provided.

In the first embodiment, the first opening 18A and the second opening 18B are symmetrically arranged with respect to the radial direction of the airbag 12; however, these openings may be asymmetrical with respect to the radial direction of the airbag 12. In the second embodiment, each of the pair of the first openings 18A and the pair of the second openings 18B is symmetrically arranged with respect to the radial direction of the airbag 12; however, the each pair of these openings may be asymmetrical with respect to the radial direction of the airbag 12.

In the second embodiment, each of the pair of the first openings 18A and the pair of the second openings 18B is symmetrically arranged with respect to the radial direction of the airbag 12; however, the arrangement of the each opening is not limited to this. For example, when the openings are arranged in four directions, any one position may be set as the first opening 18A while remaining three positions may be set as the second opening 18B. On the contrary, any one position in the four directions may be set as the second opening 18B while the remaining three positions may be set as the first opening 18A. In addition, two pairs each of the first openings 18A and the second openings 18B that are symmetrically arranged with respect to the radial direction of the airbag 12 may be provided. It should be noted that an arrangement direction of the each opening is not limited to four directions but may be three directions, five directions or more.

The way of folding the airbag 12 is not limited to the way of folding in the first embodiment, but may be another way of folding. The inner bag 14 is configured by the cloth whose inner surface is coated, and the airbag is configured by the non-coated cloth; however, presence or absence of coating can appropriately be selected.

What is claimed is:

1. A driver seat airbag system comprising:
an airbag that receives a supply of gas for inflation during a collision of a vehicle and is inflated and deployed between a steering wheel and an occupant in a driver seat;
an inner bag that has a smaller capacity than the airbag, receives the supply of gas for inflation during the collision of the vehicle, and is inflated and deployed to the outside in a radial direction of a rim in a position on a rim side of the steering wheel in the airbag; and
a check valve that inhibits outflow of the gas in the inner bag that is inflated and deployed to the airbag.

2. The driver seat airbag system according to claim 1, wherein
the gas is supplied to the inner bag,
the inner bag includes a gas flow path that is communicated with the airbag, and
the check valve is provided in the gas flow path,

3. The driver seat airbag system according to claim 2, wherein
the gas flow path is formed by a rectifying member,
the rectifying member distributes the gas to the inner bag and the airbag, and
the rectifying member includes a first opening that is opened to the inside of the inner bag and a second opening that is opened to the inside of the airbag.

4. The driver seat airbag system according to claim 3, wherein
the first opening and the second opening are symmetrically arranged with respect to the radial direction of the airbag,

5. The driver seat airbag system according to claim 4, wherein
the first opening is arranged to be oriented a lower side of the vehicle and the second opening is arranged to be oriented an upper side of the vehicle.

6. The driver seat airbag system according to claim 3, wherein
each of a pair of the first openings and a pair of the second openings is symmetrically arranged with respect to the radial direction of the airbag.

7. The driver seat airbag system according to claim 6, wherein
the pair of the first openings is symmetrically arranged in a vehicle width direction, and the pair of the second openings is symmetrically arranged in an up-and-down direction of the vehicle.

8. The driver seat airbag system according to claim 3, wherein
the second opening penetrates the inner bag and is projected to the inside of the airbag; and
the penetrated section of the inner bag is sewn on a periphery of the rectifying member.

9. The driver seat airbag system according to claim 3, wherein
a center section of the rectifying member is a portion that directly receives a pressure of the gas that is spewed out of an inflator and a cross sectional area of the center section is set to be larger than those of the first opening and the second opening; and
a cross sectional area of the rectifying member is gradually reduced from the center section to each of the first opening and the second opening.

10. The driver seat airbag system according to claim 4, wherein
after being folded along a first folding line that is along a direction in which the first opening and the second opening are present, the airbag and the inner bag are folded along a second folding line that is along a direction to cross a direction of the first folding line.

11. The driver seat airbag system according to claim 1, wherein
the inner bug is configured by a cloth whose inner surface is coated, and the airbag is configured by a non-coated cloth.

12. The driver seat airbag system according to claim 10, wherein
the airbag and the inner bag are folded along a plurality of first folding lines that extend in a same direction, and
the rectifying member is located between the plurality of first folding lines.
